(19) United States
(12) Patent Application Publication
(10) Pub. No.: US 2016/0345088 A1
(43) Pub. Date: Nov. 24, 2016

(54) CONTROLLABLY ACTUABLE FABRIC AND ASSOCIATED METHOD AND APPARATUS FOR CONTROLLING THE FABRIC

(71) Applicant: Nokia Technologies Oy, Espoo (FI)

(72) Inventors: Miikka Tapani Vilermo, Siuro (FI); Arto Juhani Lehtiniemi, Lempaala (FI); Kimmo Tapio Roimela, Tampere (FI); Koray Ozcan, Farnborough (GB)

(21) Appl. No.: 14/718,250

(22) Filed: May 21, 2015

(51) Int. Cl. H04R 1/04; H04R 1/08

(52) U.S. Cl. CPC H04R 1/04; H04R 1/083

(57) ABSTRACT

A fabric is provided to facilitate the capture of audible signals by a microphone of the fabric. The fabric includes a fabric material and a microphone positioned proximate to the fabric material. The fabric also includes a controllable patch carried by the fabric material at least partially proximate the microphone. The controllable patch is configured to be flexible in an unactuated state and to have a different shape in an actuated state. The different shape of the controllable patch in the actuated state is predetermined so as to enable to the microphone to capture audible signals. In order to control the shape of the fabric, a method and apparatus are also provided to determine that a microphone is to be utilized and to cause an actuation signal to be provided to the controllable patch while the microphone is utilized.

### TECHNOLOGICAL FIELD

An example embodiment of the present invention relates generally to a controllably actuable fabric and, more particularly, to a fabric that includes one or more microphones as well as a method and apparatus for controlling the fabric to facilitate signal capture by the one or more microphones.

### BACKGROUND

Microphones are being increasingly embedded into or otherwise carried by various fabric materials. For example, wearable computing technology is becoming increasingly prevalent and includes, among other articles of clothing, smart jackets that incorporate one or more microphones. As such, the microphones may capture signals including the voice of the user and other audible signals indicative of the context in which the user is immersed. As another example, embedded computing and embedded sensing technologies sometimes include one or more microphones that are carried by fabric material to capture various audible signals. By way of example, the upholstery within a vehicle may carry one or more microphones in order to capture the voice of the driver or other occupants of the vehicle as well as other audible signals indicative of the context within the vehicle.

Although wearable computing technology, embedded computing technology and embedded sensing technology offer a number of advantages, the microphones that are carried by a fabric material may capture an increased amount of noise so as to have a lower signal to noise ratio and a correspondingly degraded quality relative to microphones carried by dedicated computing devices, such as a smart phone or the like. In this regard, the microphones carried by a fabric material may not only capture the desired audible signals, but may also capture noise created by the fabric as the fabric is flexed or otherwise alters shape during use. For example, the fabric material that carries the microphone may contact the microphone and create noise or may wrinkle and rub against itself so as to create noise that is captured by the microphone.

In addition, the microphones carried by a fabric material may also suffer from increased signal attenuation relative to the performance of microphones carried by dedicated computing devices. In this regard, the fabric material that carries the microphones may flex during its use and the microphone may sometimes be located in a valley with the fabric material proximate the microphone extending outwardly beyond the microphone on one or both sides of the microphone. As a result of the disposition of the microphone, at least temporarily, within a valley defined by the fabric material, the microphone may be at least partially shielded from the audible signals such that the audible signals captured by the microphone are attenuated.

### BRIEF SUMMARY

A controllably actuable fabric is provided in accordance with an example embodiment with the fabric including one or more microphones carried by a fabric material. The shape of the fabric of an example embodiment, at least in the vicinity of the microphone, is configured to be controlled to facilitate the capture of audible signals by the microphone. As such, the fabric as well as the associated method and apparatus for controlling the shape of the fabric may provide for the capture of audible signals by the microphone in a manner that reduces the noise that is captured by the microphone and correspondingly increases the signal to noise ratio and the resulting quality of the audible signals captured by the microphone. Further, the robotic fabric as well as the method and apparatus for controlling the shape of the fabric of an example embodiment may reduce the attenuation of the audible signals captured by the microphone so as to further improve the quality of the signals captured by the microphone. As such, the fabric as well as the associated method and apparatus for controlling the shape of the fabric of an example embodiment of the present invention facilitate microphones being carried by fabric material in various applications including, for example, in conjunction with wearable computing technology, embedded computing technology, embedded sensing technology and the like.

In an example embodiment, a fabric is provided that includes a fabric material and a microphone positioned proximate to the fabric material. For example, the microphone of an example embodiment is co-located with a medial portion of the robotic fabric patch. The fabric also includes a controllable patch, such as a robotic fabric patch, carried by the fabric material at least partially proximate the microphone. The controllable patch is configured to be flexible in an unactuated state and to have a different shape in an actuated state. The different shape of the controllable patch in the actuated state is predetermined so as to enable the microphone to capture audible signals in the actuated state.

The microphone of an example embodiment is also configured to capture audible signals in the unactuated state. In this example embodiment, the different shape of the controllable patch in the actuated state enables the microphone to capture audible signals with improved quality in the actuated state relative to the unactuated state. The controllable patch of an example embodiment is configured to have different predetermined shapes depending upon operating conditions.

The controllable patch of an example embodiment is configured to become flatter in the actuated state than in the unactuated state. The controllable patch of an example embodiment is configured to assume a predetermined arcuate shape in the actuated state. In this regard, the fabric material includes an interior surface and an opposed exterior surface with the interior surface of the fabric material being configured to face an underlying object. In this example embodiment, the predetermined arcuate shape may be configured to lift a medial portion of the controllable patch from the underlying object. In an example embodiment, the fabric further includes protective material overlying the microphone. In this example embodiment, the predetermined arcuate shape is configured to lift the protective material from the microphone. The controllable patch may be comprised of a shape memory alloy having the predetermined shape in the actuated state.

In another example embodiment, an apparatus is provided that includes at least one processor and at least one memory including computer program code with the at least one memory and the computer program code configured to, with the at least one processor, cause the apparatus to at least determine that a microphone positioned proximate to a fabric material is configured to provide an output signal. The at least one memory and the computer program code are also configured to, with the at least one processor, cause the apparatus to cause an actuation signal to be provided to a controllable patch carried by the fabric material at least partially proximate that microphone. The actuation signal is caused to be provided to the controllable patch when the output signal is to be provided by the microphone, such as throughout provision of the output signal by the microphone, such that the controllable patch is caused to transition from being flexible in an absence of the actuation signal to a different shape in response to the actuation signal. The different shape of the controllable patch in response to the actuation signal is predetermined so as to enable the microphone to provide the output signal while the controllable patch has the different shape.

The at least one memory and the computer program code are further configured to, with the at least one processor, cause the apparatus of an example embodiment to receive a signal from the microphone and to determine whether noise is present in the signal received from the microphone, such as by determining whether the signal received from the microphone is clipped. The at least one memory and the computer program code are configured to, with the at least one processor, cause the apparatus of this example embodiment to cause the actuation signal to be provided in a manner that is dependent upon a determination that noise is present.

The at least one memory and the computer program code are configured to, with the at least one processor, cause the apparatus of an example embodiment to cause an actuation signal to be provided to the controllable patch by causing a plurality of actuation signals having different signal characteristics to be sequentially provided to the controllable patch. The at least one memory and the computer program code are further configured to, with the at least one processor, cause the apparatus of this example embodiment to receive a respective signal from the microphone while an actuation signal having each different signal characteristic is provided to the controllable patch. The at least one memory and computer program code are further configured to, with the at least one processor, cause the apparatus of this example embodiment to select the signal characteristic of the actuation signal to be thereafter provided to the controllable patch while the microphone is utilized based upon the noise included in the respective signal from the microphone while the actuation signal having each different signal characteristic is provided to the controllable patch. For example, the at least one memory and computer program code are configured to, with the at least one processor, cause the apparatus of an example embodiment to select the signal characteristic of the actuation signal to be thereafter provided to the controllable patch by selecting the signal characteristic of the actuation signal associated with the respective signal, from the microphone, that includes the least noise.

The microphone of an example embodiment is also configured to capture audible signals in the unactuated state. In this example embodiment, the different shape of the controllable patch in the actuated state enables the microphone to capture audible signals with improved quality in the actuated state relative to the unactuated state. The controllable patch of an example embodiment is configured to have different predetermined shapes depending upon operating conditions.

In a further example embodiment, a method is provided that includes determining that a microphone positioned proximate to a fabric material is configured to provide an output signal and causing an actuation signal to be provided to a controllable patch carried by the fabric material at least partially proximate the microphone. The actuation signal is caused to be provided to the controllable patch when the output signal is provided by the microphone, such as throughout provision of the output signals by the microphone, such that the controllable patch is caused to transition from being flexible in an absence of the actuation signal to a different shape in response to the actuation signal. The different shape of the controllable patch in response to the actuation signal is predetermined so as to enable the microphone to capture audible signals while the controllable patch has assumed the different shape.

The method of an example embodiment also includes receiving a signal from the microphone and determining whether noise is present in the signal received from the microphone, such as by determining whether the signal received from the microphone is clipped. In this example embodiment, the method causes the actuation signal to be provided in a manner that is dependent upon a determination that noise is present.

The method of an example embodiment causes an actuation signal to be provided to the controllable patch by causing a plurality of actuation signals having different signal characteristics to be sequentially provided to the controllable patch. The method of this example embodiment also includes receiving a respective signal from the microphone while the actuation signal having each different signal characteristic is provided to the controllable patch and selecting the signal characteristic of the actuation signal to be thereafter provided to the controllable patch while the microphone is utilized based upon noise included in the respective signals from the microphone while the actuation signal having each different signal characteristic is provided to the controllable patch. The method of this example embodiment may select the signal characteristic of the actuation signal to be thereafter provided to the controllable patch by selecting the signal characteristic of the actuation signal associated with the respective signal, from the microphone, that includes the least noise.

The microphone of an example embodiment is also configured to capture audible signals in the unactuated state. In this example embodiment, the different shape of the controllable patch in the actuated state enables the microphone to capture audible signals with improved quality in the actuated state relative to the unactuated state. The controllable patch of an example embodiment is configured to have different predetermined shapes depending upon operating conditions.

In another example embodiment, a computer program product is provided that includes at least one non-transitory computer-readable storage medium having computer-executable program code portions stored therein with the computer-executable program code portions including program code instructions configured to determine that a microphone positioned proximate to a fabric material is configured to provide an output signal and to cause an actuation signal to be provided to a controllable patch carried by the fabric material at least partially proximate the microphone. The actuation signal is caused to be provided to the controllable patch when the output signal is to be provided by the microphone such that the controllable patch is caused to transition from being flexible in an absence of the actuation signal to a different shape in response to the actuation signal. The different shape of the controllable patch in response to the actuation signal is predetermined so as to enable the microphone to provide the output signal while the controllable patch has the different shape.

In yet another example embodiment, an apparatus is provided that includes means for determining that a microphone positioned proximate to a fabric material is configured to provide an output signal. The apparatus also include means for causing an actuation signal to be provided to a controllable patch carried by the robotic material at least partially proximate the microphone. The actuation signal is caused to be provided to the controllable patch while the output signal is to be provided by the microphone such that the controllable patch is caused to transition from being flexible in an absence of the actuation signal to a different shape in response to the actuation signal. The different shape of the controllable patch in response to the actuation signal is predetermined so as to enable the microphone to provide the output signal while the controllable patch has the different shape.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a fabric in which the fabric material is flexed such that the microphone is disposed within a valley;

FIG. 2 is a block diagram of an apparatus that may be specifically configured in accordance with an example embodiment of the present invention in order to control a fabric;

FIG. 3 is a plan view of a controllable patch in accordance with an example embodiment of the present invention;

FIG. 4 is a flowchart depicting operations performed, such as by the apparatus of FIG. 1, in accordance with an example embodiment of the present invention;

FIG. 5 illustrates the fabric of FIG. 1 in which the controllable patch is in an actuated state such that the controllable patch becomes flatter in accordance with an example embodiment of the present invention;

FIG. 6 illustrates the fabric of FIG. 1 in which the controllable patch is in an actuated state such that the controllable patch assumes a predetermined arcuate shape in accordance with an example embodiment of the present invention;

FIG. 7A illustrates a fabric including a protective material overlying the microphone;

FIG. 7B illustrates the fabric of FIG. 7A in which the controllable patch is in an actuated state and has assumed a predetermined arcuate shape so as to lift the protective material from the microphone in accordance with an example embodiment of the present invention; and

FIG. 8 is a flowchart illustrating operations performed, such as by the apparatus of FIG. 1, in accordance with an example embodiment of the present invention in order to determine the extent of actuation of the controllable patch.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

A fabric 10, such as a robotic fabric, is provided in accordance with an example embodiment as well as a method, apparatus 20, and computer program product for controlling the robotic fabric. The fabric may include one or more microphones 14 which may, in turn, capture audible signals for various purposes including as input for a wearable computing system, an embedded computing system, an embedded sensing system or the like. By appropriately controlling the fabric, the audible signals captured by a microphone of the fabric are of a greater quality, such as by having reduced noise as evidenced by a greater signal to noise ratio and/or reduced signal attenuation. As such, in instances in which the microphone provides input for a wearable computing system, an embedded computing system, an embedded sensing system or the like, the performance of the wearable computing system, embedded computing system, embedded sensing system or the like may be correspondingly improved.

The fabric 10 of an example embodiment includes a fabric material 12. The fabric material may be formed of any of a variety of different types of fabric including fabric materials formed of natural fibers, such as cotton, fabric materials formed of synthetic fibers, such as polyester, and fabric materials formed of a blend of natural and synthetic fibers. Regardless of the composition of the fabric material, the fabric material is flexible so as to bend and assume various shapes. The fabric material may be utilized in a variety of applications including as an article of clothing, such as a jacket, a shirt, or a hat, in order to support, for example, a wearable computing system. Alternatively, the fabric material may be utilized as the upholstery of a vehicle, such as for the seats of a vehicle, the headliner of a vehicle or the like, or for various items of furniture, such as a desk chair, a theater seat, a seat utilized for gaming or the like. By way of further example of the wide ranging applications of the fabric material, the fabric material may be utilized by any of various systems and products, such as bags, sports equipment, portable and non-portable devices that include a fabric section, etc. Regardless of the application in which the fabric material is disposed, the fabric material includes an interior surface and an opposed exterior surface. The interior surface of the fabric material is configured to face an underlying object. For example, fabric material that comprises an article of clothing includes an interior surface that is configured to face the wearer of the article of clothing. As another example, the fabric material that comprises the upholstery of a vehicle, such as the seat of a vehicle, includes an interior surface that faces the frame, padding or other interior components of the seat.

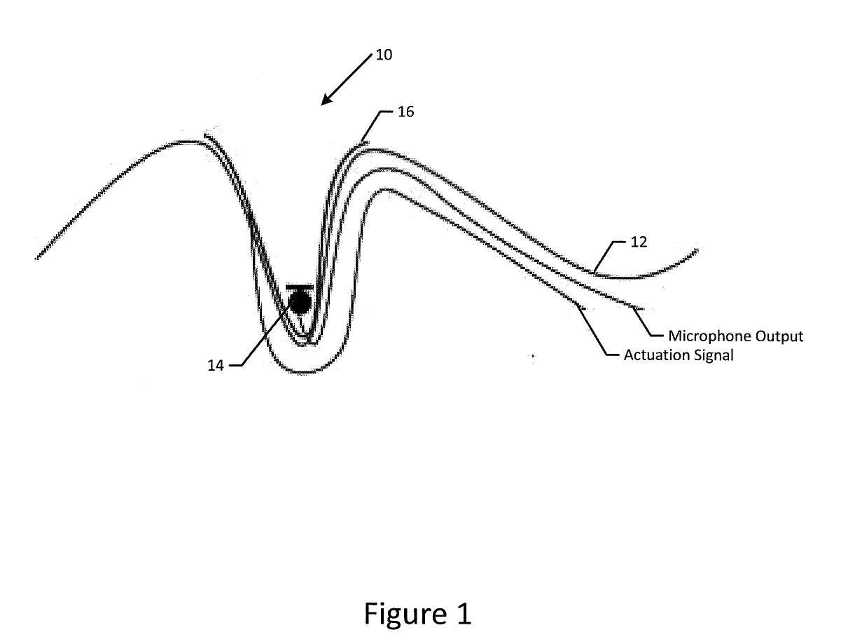

In accordance with an example embodiment, the fabric 10 also includes a microphone 14 positioned proximate to, e.g., carried by, the fabric material 12. Although a fabric that includes a single microphone is depicted in FIG. 1, the fabric may include a plurality of microphones, such as a plurality of microphones carried by different portions of the fabric material. In an example embodiment, the microphone is secured to the fabric material, such as by adhesive, stitching or the like. In another embodiment, the microphone may be secured to another component of the fabric, such as another layer of material that is positioned proximate the fabric material. Regardless of the manner in which the microphone is carried by the fabric material, the microphone is configured to move in tandem with the portion of the fabric material with which the microphone is proximate.

As a result of the flexibility of the fabric material 12 and the uncontrolled environment in which the fabric 10 including the fabric material and the microphone 14 carried by the fabric material may be disposed, the fabric material proximate the microphone may flex and bend and may create noise that is captured by the microphone, such as the result of the fabric material rubbing against the microphone or rubbing against itself in the vicinity of the microphone. Additionally, the fabric material may sometimes bend or fold in a manner shown in FIG. 1 in which the microphone is disposed in a valley defined by the fabric material. In this instance, the position of the microphone within the valley causes the microphone to be at least partially shielded from the audible signals such that the signals captured by the microphone are attenuated relative to the signals captured by the microphone in an instance in which the fabric material is unfolded and the microphone is not disposed within a valley defined by the fabric material.

In order to control the shape of the fabric material 12 proximate the microphone 14 and, in turn, to improve the quality of the signals captured by the microphone, the fabric 10 of an example embodiment includes a controllable, such as a controllably actuable patch, e.g., a robotic fabric patch 16, carried by the fabric material at least partially proximate the microphone. The controllable patch may be secured to the fabric material, such as by an adhesive, stitching or the like. Alternatively, the controllable patch may be positioned proximate the fabric material in such a manner that the controllable patch and the fabric material that is aligned with the controllable patch move in unison. Although the microphone may be secured to the fabric material in an example embodiment, the microphone may alternatively be carried by the controllable patch, such as by being adhered, stitched or otherwise mechanically connected to the controllable patch. In either instance, the microphone is configured to move in tandem with the portion of the fabric material that is proximate the microphone.

The controllable patch 16 is actuable so as to alternate between an unactuated state and an actuated state. In the unactuated state, the controllable patch is configured to be flexible, such as in the same manner in which the fabric material 12 is flexible. In the actuated state, however, the controllable patch is configured to transition to a different shape, such as a flat or planer shape or an arcuate or bowed shape as described below. The different shape of the controllable patch in the actuated state is predetermined. By actuating the controllable patch in instances in which the microphone 14 is to capture audible signals, the controllable patch and, in turn, the fabric material aligned therewith may be reconfigured so as to position the microphone in a manner to capture the audible signals. In embodiments in which the microphone also captured signals while the controllable patch was in the unactuated state, the microphone may capture audible signals with greater quality, such as with less noise, greater signal to noise ratio, less attenuation or the like while the controllable patch was in the actuated state than while the controllable patch was in the unactuated state.

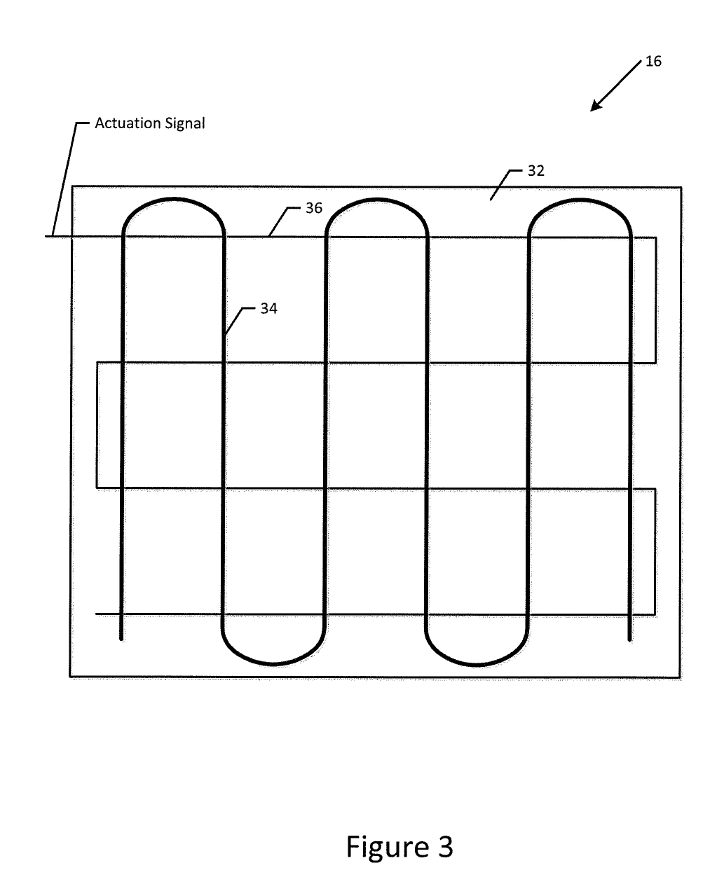

The controllable patch 16 may be configured in various manners. In an example embodiment depicted in FIG. 3, however, the controllable patch is comprised of a robotic fabric patch that includes a layer of fabric 32, such as a layer of muslin, an inelastic woven cotton material, and a shape memory alloy (SMA) wire 34 integrated into or otherwise carried by the layer of fabric. Although the SMA wire is shown to extend in a serpentine pattern, the SMA wire may have other configurations in other embodiments. The SMA wire may be comprised of various SMA materials with the SMA wire of an example embodiment being comprised of nickel titanium (NiTi). The shape memory alloy has been formed so as to be flexible in an unactuated state and to assume the predetermined shape in the actuated state.

In another example embodiment, the robotic fabric patch 16 is formed of a memory foam that is flexible when warmed, such as by body heat, but that hardens when cooled, thereby retaining its shape. In a further example embodiment, the robotic fabric patch is formed of a polyhydroxybutyrate material that is flexible at room temperature or when warmed, such as by body heat, but that becomes rigid so as to retain its shape when cooled, such as with a Peltier element. In yet another example embodiment, the robotic fabric path may be formed of a shape memory polymer that is able to return to its original shape after being stretched to some degree. Still further, the robotic fabric patch may be formed of a fabric formed of a shape memory alloy and fibers comprised of polyactide or another shape memory polymer. In this embodiment, the fabric is flexible when the polyactide fibers are heated and the shape memory alloy is not electrically actuated. When the fabric of this example embodiment is to assume a predefined rigid shape, however, the shape memory alloy is initially electrically actuated which causes the fabric to assume the predefined rigid shape and the heat is then removed from the polyactide fibers in order to lock the fabric into the predefined shape.

The shape memory alloy may be actuated in various manners. In an example embodiment described in more detail below, the robotic fabric patch 16 and, in particular, the SMA wire 34 is actuated by the application of heat to the SMA wire which, in turn, causes the SMA wire to assume the predetermined shape. The robotic fabric patch may, in turn, be heated in various manners. In the illustrated embodiment, however, the robotic fabric patch includes a heating element, such as an electrical heating wire 36, carried by or included within the robotic fabric patch. Although the electrical heating wire is shown in FIG. 3 to have a serpentine pattern that is disposed in an orthogonal relationship to the serpentine pattern of the SMA wire, the electrical heating wire may have other configurations in other embodiments. The electrical heating wire is responsive to, e.g., heated by, an actuation signal as described below with the heating of the electrical heating wire causing the SMA wire to correspondingly be heated and the robotic fabric patch to assume the predetermined shape. For example, the electrical heating wire of an example embodiment may provide resistive heating to the SMA wire as a result of a current created by the actuation signal flowing therethrough.

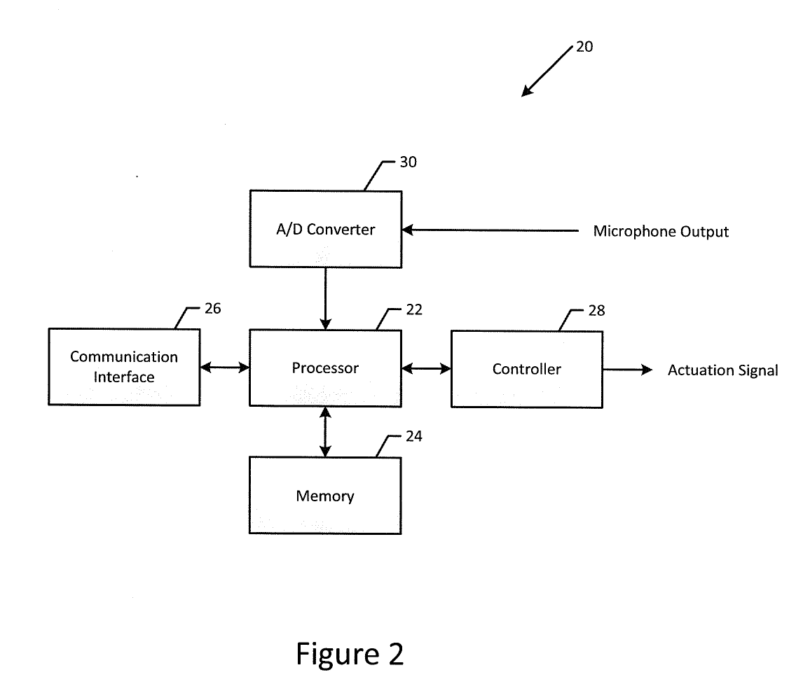

The fabric 10 and, in particular, the controllable patch 16, may be controlled in various manners. In an example embodiment, an apparatus 20 is provided, an example of which is depicted in FIG. 2, in order to controllably actuate the controllable patch. The apparatus may be embodied in various manners including by a computing device, such as a mobile terminal, such as a personal digital assistant (PDA), mobile telephone, smart phone, companion device, for example, a smart watch, gaming device, laptop computer, tablet computer, touch surface or any combination of the aforementioned, and other types of voice and text communications systems. Alternatively, the computing device that embodies the apparatus may be a fixed computing device, such as a personal computer, a computer workstation, a kiosk or the like.

Although the apparatus 20 configured to control the actuation of the controllable patch 16 may be configured in various manners, the example of the apparatus depicted in FIG. 2 includes, is associated with or is otherwise in communication with a processor 22, a memory device 24 and a communication interface 26. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a computing device. However, in some embodiments, the apparatus may be embodied as a chip or chip set. In other words, the apparatus may comprise one or more physical packages (for example, chips) including materials, components and/or wires on a structural assembly (for example, a circuit board). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment also includes a communication interface 26 that may be any means such as a device or circuitry embodied in either hardware or a combination of hardware and software that is configured to receive and/or transmit data from/to other electronic devices in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication.

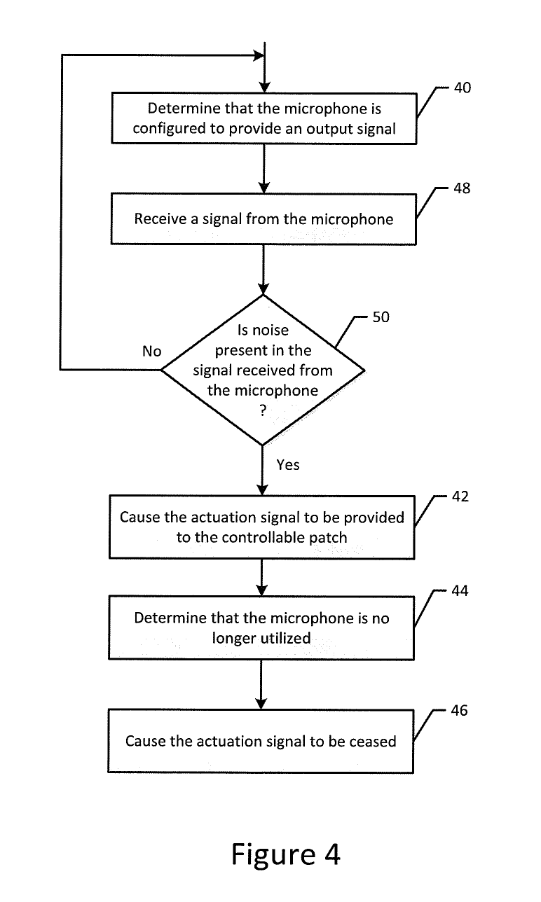

As the actuation of the controllable patch 16 consumes energy, the method and apparatus 20 of an example embodiment are configured to selectively actuate the controllable patch in instances in which the microphone 14 is to be utilized and not in instances in which the microphone is not utilized. For example, the microphone may be utilized to provide an output signal, such as by providing an electrical output signal representative of an audible signal that the microphone has captured or by outputting an audible output signal Accordingly, as shown in block 40 of FIG. 4, the apparatus includes means, such as the processor 22 or the like, for determining that a microphone carried by the fabric material 12 is configured to provide an output signal. The apparatus, such as the processor, is configured to determine that the microphone is to be utilized in various manners, but, in one embodiment, the determination as to whether the microphone is to be utilized is dependent upon the state or context of the computing system that receives the audible signals from the microphone. For example, in instances in which the computing system is configured to open the microphone and to receive audible signals therefrom, the apparatus, such as the processor, is correspondingly configured to determine that the microphone carried by the fabric material is to be utilized.

The apparatus 20 also includes means, such as the processor 22, a controller 28 or the like, for causing an actuation signal to be provided to the controllable patch 16 carried by the fabric material 12 proximate the microphone 14. See block 42 of FIG. 4. In an example embodiment, the processor causes the actuation signal to be provided to the controllable patch by providing the actuation signal directly to the robotic fabric patch. Alternatively, the processor of an example embodiment is configured to cause the actuation signal to be provided to the controllable patch by triggering a controller to, in turn, transmit the actuation signal to the controllable patch. The controller may be embodied in various manners, such as a current source such that an actuation signal having a sufficiently larger current may be provided to, for example, the robotic fabric patch so as to heat the robotic fabric patch, such as by resistive heating, and cause the SMA wire to assume the predetermined shape.

The actuation signal is cause to be provided to the controllable patch 16 when the microphone 14 is utilized, such as when the output signal is to be provided by the microphone and, in an example embodiment, throughout the provision of the output signal by the microphone. Once the apparatus 20, such as the processor 22, determines that the microphone is no longer to be utilized, such as based upon the state or context of the computing system that embodies or is associated with the apparatus, the actuation signal may be ceased. See blocks 44 and 46 of FIG. 4. In an instance in which the microphone is to be utilized and in response to the actuation signal, however, the apparatus, such as the processor, causes the controllable patch to assume the different predetermined shape, such as by causing the heating element 36 of a robotic fabric patch to generate heat in order to actuate the SMA wire 34 such that the robotic fabric patch assumes the predetermined shape defined by the SMA wire in the actuated state.

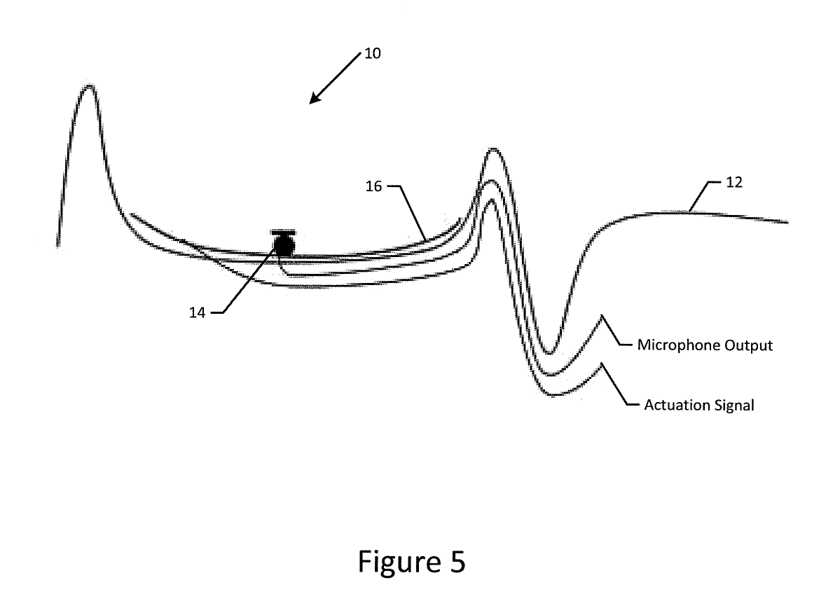

The controllable patch 16 may assume various predetermined shapes, such as defined by the predetermined shape that the SMA wire 34 has been fabricated or trained to have in the actuated state. In an example embodiment depicted in FIG. 5, the controllable patch is configured to have a predetermined shape that is planer or at least flatter in the actuated state than in the unactuated state. By having a planer or flatter shape, the portion of the fabric material 12 proximate the microphone 14 is unfolded such that the microphone is not disposed within a valley defined by the fabric material as shown in FIG. 1, thereby reducing signal attenuation that may otherwise occur in these situations. Additionally, the unfolding of the fabric material in the vicinity of the microphone in an instance in which the predetermined shape of the controllable patch is planer or flatter also reduces, if not eliminates, the noise created by the fabric material rubbing against the microphone or rubbing against itself in the vicinity of the microphone. As such, the resulting audible signal captured by the microphone has an improved signal to noise ratio and improved signal quality.

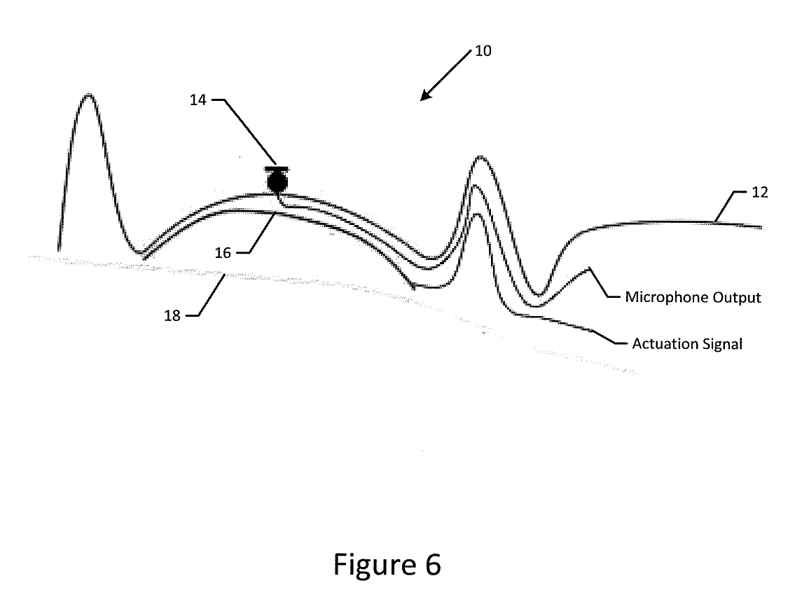

Alternatively, the predetermined shape assumed by the controllable patch 16, such as the result of the fabrication or training of the SMA wire 34, may be a predetermined arcuate or bowed shape as shown in FIG. 6 or at least more bowed in the actuated state than in the unactuated state. As described above in which the predetermined shape in the actuated state was a planer or flatter shape, the predetermined arcuate shape of the controllable patch also prevents the microphone 14 from being disposed within a valley defined by the fabric material 12 and also reduces, if not eliminates, noise created by a fabric material rubbing across the microphone or the fabric material rubbing against itself in the vicinity of the microphone so as to improve the quality of the audible signals captured by the microphone. In an embodiment in which the interior surface of the fabric material faces an underlying object, the predetermined arcuate shape lifts a medial portion of the controllable patch from the underlying object 18, thereby also avoiding any noise created by rubbing of the fabric material against the underlying object in the vicinity of the microphone.

The controllable patch 16 of an example embodiment may be configured to have a plurality of different predetermined shapes. For example, the controllable patch may be configured to transition to each of the different predetermined shapes in response to a different respective actuation signal. In this regard, the actuation signal to be provided to the controllable patch may be dependent upon the operating conditions, such as the level of noise in the vicinity of the microphone, the amplitude of the audible signals to be captured, the level of wind in the vicinity of the microphone or the like. As such, depending upon the operating conditions, the actuation signal that causes the controllable patch to transition to the different shape that is desired in light of the operating conditions may be determined, such as by the processor 22, the controller 38 or the like of an apparatus 20 as described below, and thereafter provided to the controllable patch.

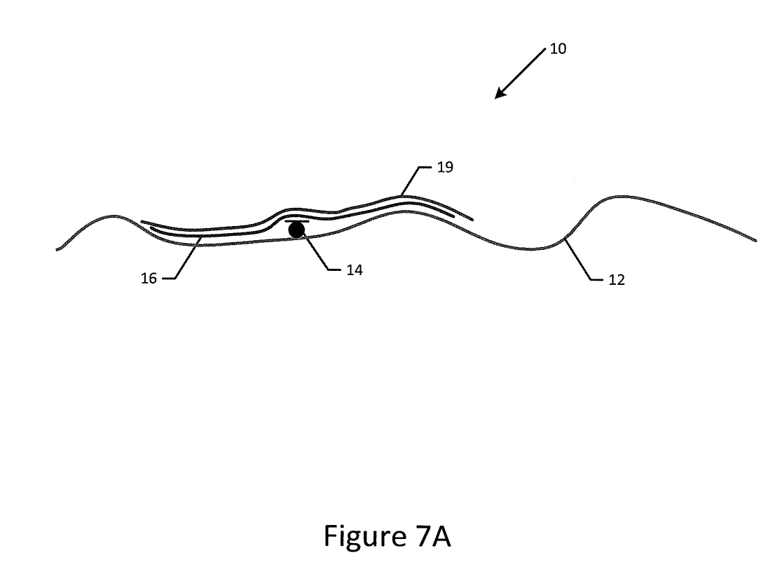

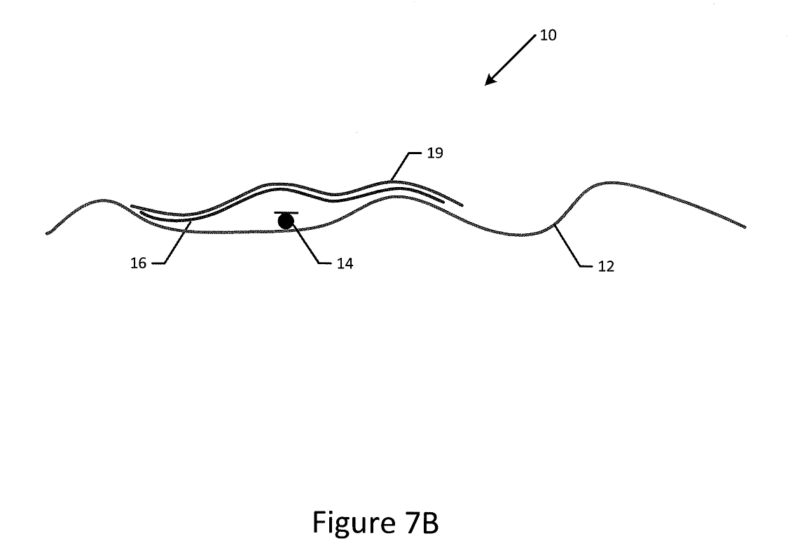

As shown in FIG. 7A, the fabric 10 of an example embodiment includes a protective material 19, such as a protective material comprised of foam rubber, polyurethane, artificial fur or other fabrics, overlying the microphone 14. While examples of a protective material are provided above, the protective material may be any of various materials that is configured to recover its shape and may serve a protective function. In example embodiments, the protective material will be flexible and stretchable, such as a material formed of a carbon nanotube network or a graphene ribbon network or a polymer or other thin material that defines one or more cracks, e.g., microscale cracks, that contribute to the stretchability of the protective material. Other examples of the protective material include an electroactive polymer as described by US Patent Application Publication No. US 2011/0268292 and a web of flexible polymer as described by US Patent Application Publication No. US 2014/0341420. In addition to protecting the microphone from water, contaminants or the like, the protective material may also serve an aesthetic function.

In an example embodiment, the controllable patch 16 may be positioned between the microphone 14 and the protective material 19. Alternatively, the controllable patch may be positioned on the opposite side of the protective material from the microphone and secured to the protective material such that the protective material and the controllable patch move in unison with one another. In the example embodiment of FIG. 7A, the protective material may overlie and be in contact with the microphone in the unactuated state, either directly or indirectly via the intervening controllable patch as shown in FIG. 6A. However, in the actuated state depicted in FIG. 7B, the controllable patch is caused to assume a predetermined arcuate shape so as to lift the protective material from the microphone. As such, the microphone is configured to capture audible signals without the noise that might otherwise be created by rubbing of the protective material over the microphone such that the resulting audible signals that are captured by the microphone are of a higher quality. In addition to or instead of reshaping the protective material so as to lift the protective material from the microphone, as shown in FIG. 7B, the protective material may define a plurality of apertures and the controllable patch of another example embodiment may be actuated so as to cause the plurality of apertures defined by the protective material to be opened to facilitate the capture of audible signals.

As noted above, the actuation of the controllable patch 16 may consume energy. As such, the method and apparatus 20 of an example embodiment are configured to not necessarily actuate the controllable patch in every instance in which the microphone is to be utilized and to, instead, only actuate the controllable patch in an instance in which the audible signals captured by the microphone include noise or at least a predefined amount or percentage of noise, such as defined by the signal to noise rate or by other measures.

In this example embodiment; the apparatus 20 includes means, such as the processor 22, the communication interface 26, the analog-to-digital (A/D) converter 30 or the like, for receiving a signal from the microphone 14, as shown in block 48 of FIG. 4. By way of example, the microphone is configured to capture audible signals and to provide analog signals representative of the audible signals. Although the processor or the communication interface may be configured to directly receive the analog signals from the microphone in some embodiments, the apparatus of the embodiment of FIG. 2 includes or be associated with an A/D converter that is configured to convert the analog signals provided by the microphone to corresponding digital signals which, in turn, are provided to the processor for processing, replay, output, storage or the like. Regardless of the manner in which the signals from the microphone are received, the apparatus of this example embodiment also includes means, such as the processor or the like, for determining whether noise is present in the signals received from the microphone. See block 50 of FIG. 4. The actuation signal provided by the apparatus, such as the processor, is then dependent upon a determination that noise is present. As such, the actuation signal is provided only in response to a determination that noise is present and not in an instance in which the microphone is utilized, but the audible signals captured by the microphone do not include noise. As such, the energy consumed by the actuation of the controllable patch 16 may be conserved and utilized only in an instance in which the audible signals captured by the microphone include noise and in which the assumption of the predetermined shape by the controllable patch will allow for an improvement in the audible signals captured by the microphone as a result of the reduction in the noise included within the audible signals.

The determination as to whether noise is present in the signals provided by microphone 14 may be accomplished in various manners. In an example embodiment, the apparatus 20, such as the processor 22, is configured to determine not just that the signals provided by the microphone include any noise, but if the signals provided by the microphone include sufficient noise to justify the investment of the energy required to actuate the controllable patch 16. For example, the apparatus, such as the processor, may be configured to determine the signal to noise ratio of the audible signals captured by the microphone and to determine that the signals include noise in an instance in which the signal to noise ratio falls below a predefined threshold. Alternatively, the apparatus, such as the processor, is configured to determine that the signals received from the microphone include noise in an instance in which the signals received from the microphone are clipped. As such, the apparatus, such as the processor, of this example embodiment is configured to determine that the signal received from the microphone does not include noise in an instance in which the signal is not clipped.

In an example embodiment, the controllable patch 16 does not simply transition between being fully flexible in an unactuated state to assuming the predetermined shape in the actuated state, but, instead, can assume a number of different shapes between being fully flexible and assuming the predetermined shape depending upon the degree of actuation, such as depending upon the amount of heating of the robotic fabric patch as created by the actuation signal. For example, in an instance in which a robotic fabric patch is heated by an electrical heating wire 36, the magnitude of the current flowing through the electrical heating wire controls the degree of actuation with the robotic fabric patch being more fully actuated up to and including the predetermined shape in response to larger current magnitudes and being actuated to a lesser degree in response to smaller current magnitudes.

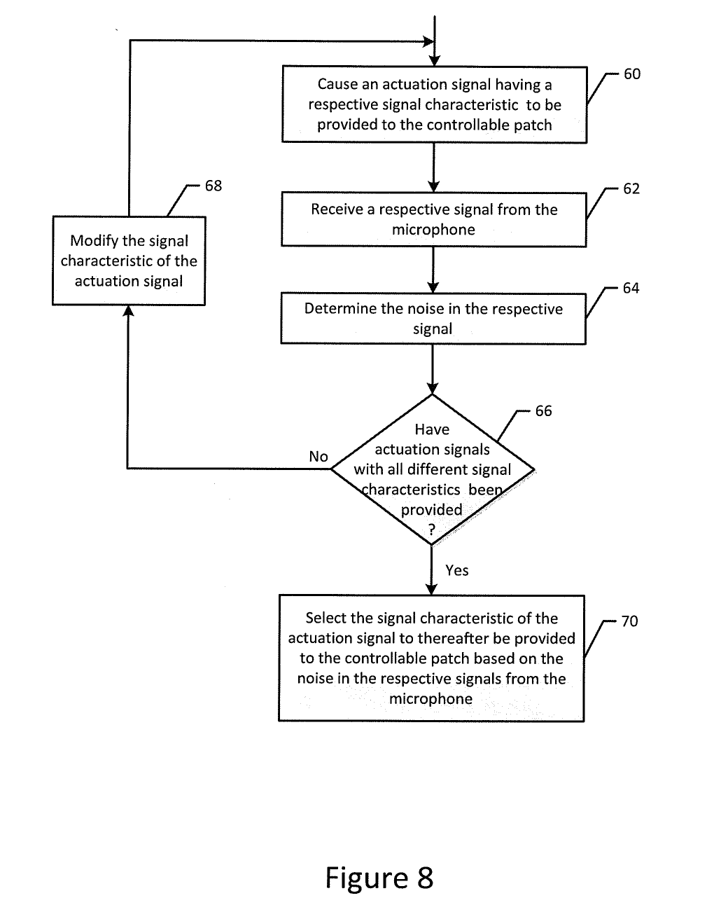

In this example embodiment, each different shape assumed by the controllable patch 16 between being fully flexible and the predetermined shape defines a relationship between the quality of the audible signals captured by the microphone 14 and the energy that is expended to cause the controllable patch to be at least partially actuated. As such, the method and apparatus 20 of an example embodiment are configured to determine the extent to which the controllable patch should be actuated in order to obtain audible signals of the desired quality while conserving, to the extent possible, the energy required for actuation of the controllable patch. As shown in block 60 of FIG. 8, the apparatus of this example embodiment includes means, such as the processor 22, the controller 38 or the like, for providing an actuation signal having a respective signal characteristic to the controllable patch. The apparatus of this example embodiment also include means, such as the processor, the communication interface 26, the A/D converter 30 or the like, for receiving a respective signal from the microphone while the actuation signal having the respective signal characteristic is provided to the controllable patch. See block 62 of FIG. 8. The apparatus also includes means, such as the processor or the like, determining the noise in the signal received from the microphone, such as by determining the signal to noise ratio of the signal. See block 64 of FIG. 8.

As actuation signals having a plurality of different signal characteristics are to be provided to the controllable patch 16 in order to determine the noise level of the signals captured by the microphone 14 in response to different degrees of actuation, the apparatus 20 also includes means, such as the processor 22 or the like, for determining whether actuation signals having all of the various signal characteristics have been provided. See block 66. If not, the apparatus includes means, such as the processor or the like, for modifying the signal characteristic of the actuation signal and then repeating the process of providing the controllable patch with the actuation signal having the respective signal characteristic, receiving a respective signal from the microphone and determining the noise in the signal provided by the microphone. The signal characteristic that is modified may be any one of various signal characteristics including, for example, magnitude, frequency, bandwidth, shape, etc. Once the actuation signals having all of the different signal characteristics have been provided to the controllable patch, the apparatus includes means, such as the processor or the like, for comparing the respective signals received from the microphone while actuation signals of each different signal characteristic are provided to the controllable patch and selecting the signal characteristic of the actuation signal to be thereafter provided to the controllable patch while the microphone is utilized based upon the noise included in the respective signals from the microphone while actuation signals of each different signal characteristic are provided to the controllable patch. Although the signal characteristic of the actuation signal to be thereafter provided to the controllable patch may be selected in various manners, the apparatus, such as the processor, of an example embodiment is configured to select the signal characteristic of the actuation signal associated with the respective signal from the microphone having the least noise.

Thus, the method and apparatus 20 of this example embodiment are configured to cause an actuation signal having the selected signal characteristic to be provided to the controllable patch 16 in subsequent instances in which the microphone 14 is determined to be utilized. As such, the noise captured by the microphone may be reduced, if not minimized, and the resulting quality of the audible signals captured by the microphone may be improved without unnecessarily expending energy in relation to the actuation of the controllable patch that does not result in further improved audible signals being captured.

FIGS. 3 and 8 illustrate flowcharts of an apparatus 20, method and computer program product according to example embodiments of the invention. It will be understood that each block of the flowcharts, and combinations of blocks in the flowcharts, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, some of which have been described above. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A fabric comprising:
a fabric material;
a microphone positioned proximate the fabric material; and
a controllable patch carried by the fabric material and at least partially proximate the microphone, wherein the controllable patch is configured to be flexible in an unactuated state and to have a different shape in an actuated state, wherein the different shape of the controllable patch in the actuated state is predetermined so as to enable the microphone to capture audible signals in the actuated state.

2. A fabric according to claim 1 wherein the microphone is also configured to capture audible signals in the unactuated state, and wherein the different shape of the controllable patch in the actuated state enables the microphone to capture audible signals with improved quality in the actuated state relative to the unactuated state.

3. A fabric according to claim 1 wherein the controllable patch is configured to have different predetermined shapes depending upon operating conditions.

4. A fabric according to claim 1 wherein the microphone is co-located with a medial portion of the controllable patch.

5. A fabric according to claim 1 wherein the controllable patch is configured to at least one of:
become flatter in the actuated state than in the unactuated state; or
assume a predetermined arcuate shape in the actuated state.

6. A fabric according to claim 5 wherein the fabric material comprises an interior surface and an opposed exterior surface, wherein the interior surface of the fabric material is configured to face an underlying object, and wherein the predetermined arcuate shape is configured to lift a medial portion of the controllable patch from the underlying object.

7. A fabric according to claim 5 further comprising protective material overlying the microphone, wherein the predetermined arcuate shape is configured to lift the protective material from the microphone.

8. A fabric according to claim 1 wherein the controllable patch comprises a shape memory alloy having the predetermined shape in the actuated state.

9. An apparatus comprising at least one processor and at least one memory including computer program code, the at least one memory and computer program code configured to, with the at least one processor, cause the apparatus to at least:
determine that a microphone positioned proximate to a fabric material is configured to provide an output signal; and
cause an actuation signal to be provided to a controllable patch carried by the fabric material and at least partially proximate the microphone, wherein the actuation signal is caused to be provided to the controllable patch when the output signal is to be provided by the microphone such that the controllable patch is caused to transition from being flexible in an absence of the actuation signal to a different shape in response to the actuation signal, wherein the different shape of the controllable patch in response to the actuation signal is predetermined so as to enable the microphone to provide the output signal while the controllable patch has the different shape.

10. An apparatus according to claim 9 wherein the actuation signal is caused to be provided throughout provision of the output signal by the microphone.

11. An apparatus according to claim 9 wherein the at least one memory and computer program code are further configured to, with the at least one processor, cause the apparatus to:
receive a signal from the microphone; and
determine whether noise is present in the signal received from the microphone,
wherein the at least one memory and computer program code are configured to, with the at least one processor, cause the apparatus to cause the actuation signal to be provided in a manner that is dependent upon a determination that noise is present.

12. An apparatus according to claim 11 wherein the at least one memory and computer program code are configured to, with the at least one processor, cause the apparatus to determine whether noise is present in the signal received from the microphone by determining whether the signal received from the microphone is clipped.

13. An apparatus according to claim 9 wherein the at least one memory and computer program code are configured to, with the at least one processor, cause the apparatus to cause an actuation signal to be provided to the controllable patch by causing a plurality of actuation signals having different signal characteristics to be sequentially provided to the controllable patch, wherein the at least one memory and computer program code are further configured to, with the at least one processor, cause the apparatus to:
receive a respective signal from the microphone while an actuation signal having each different signal characteristic is provided to the controllable patch; and
select the signal characteristic of the actuation signal to be thereafter provided to the controllable patch while the microphone is utilized based upon noise included in the respective signals from the microphone while the actuation signal having each different signal characteristic is provided to the controllable patch.

14. An apparatus according to claim 13 wherein the at least one memory and computer program code are configured to, with the at least one processor, cause the apparatus to select the signal characteristic of the actuation signal to be thereafter provided to the controllable patch by selecting the signal characteristic of the actuation signal associated with the respective signal, from the microphone, that includes the least noise.

15. An apparatus according to claim 9 wherein the microphone is also configured to capture audible signals in the unactuated state, and wherein the different shape of the controllable patch in the actuated state enables the microphone to capture audible signals with improved quality in the actuated state relative to the unactuated state.

16. An apparatus according to claim 9 wherein the controllable patch is configured to have different predetermined shapes depending upon operating conditions.

17. A method comprising:
deter mining that a microphone positioned proximate a fabric material is configured to provide an output signal; and
causing an actuation signal to be provided to a controllable patch carried by the fabric material at least partially proximate the microphone, wherein the actuation signal is caused to be provided to the controllable patch when the output signal is provided by the microphone such that the controllable patch is caused to transition from being flexible in an absence of the actuation signal to a different shape in response to the actuation signal, wherein the different shape of the controllable patch in response to the actuation signal is predetermined so as to enable the microphone to provide the output signal while the controllable patch has the different shape.

18. A method according to claim 17 wherein the actuation signal is caused to be provided throughout provision of the output signals by the microphone.

19. A method according to claim 17 further comprising:
receiving a signal from the microphone; and
determining whether noise is present in the signal received from the microphone,
wherein causing the actuation signal to be provided is dependent upon a determination that noise is present.

20. A method according to claim 19 wherein determining whether noise is present in the signal received from the microphone comprises determining whether the signal received from the microphone is clipped.

21. A method according to claim 17 wherein causing an actuation signal to be provided to the controllable patch comprises causing a plurality of actuation signals having different signal characteristics to be sequentially provided to the controllable patch, wherein the method further comprises receiving a respective signal from the microphone while an actuation signal having each different signal characteristic is provided to the controllable patch; and selecting the signal characteristic of the actuation signal to be thereafter provided to the controllable patch while the microphone is utilized based upon noise included in the respective signals from the microphone while the actuation signal having each different signal characteristic is provided to the controllable patch.

22. A method according to claim 21 wherein selecting the signal characteristic of the actuation signal to be thereafter provided to the controllable patch comprises selecting the signal characteristic of the actuation signal associated with the respective signal, from the microphone, that includes the least noise.

23. A method according to claim 17 wherein the microphone is also configured to capture audible signals in the unactuated state, and wherein the different shape of the controllable patch in the actuated state enables the microphone to capture audible signals with improved quality in the actuated state relative to the unactuated state.

24. A method according to claim 17 wherein the controllable patch is configured to have different predetermined shapes depending upon operating conditions.
